(19) United States
(12) Patent Application Publication
(10) Pub. No.: US 2024/0386315 A1
(43) Pub. Date: Nov. 21, 2024

(54) TRANSFORMER MODEL FOR JOURNEY SIMULATION AND PREDICTION

(71) Applicant: ADOBE INC., SAN JOSE, CA (US)

(72) Inventors: Thomas BOUCHER, Hanches (FR); Tanay ANAND, Noida (IN); Stephane LECERCLE, Herblay (FR); Saurabh GARG, San Jose, CA (US); Pranjal PRASOON, Jharkhand (IN); Nikaash PURI, New Delhi (IN); Mukul LAMBA, Himachal Pradesh (IN); Milan AGGARWAL, Delhi (IN); Jayakumar SUBRAMANIAN, Maharashtra (IN); Francoise CORVAISIER, Paris (FR); David MENDEZ ACUNA, Paris (FR); Camel AISSANI, Livry-Gargan (FR); Balaji KRISHNAMURTHY, Uttar Pradesh (IN)

(21) Appl. No.: 18/318,524

(22) Filed: May 16, 2023

(51) Int. Cl. G06N 20/00; G06N 5/022

(52) U.S. Cl. CPC G06N 20/00; G06N 5/022

(57) ABSTRACT

Methods and systems are provided for a transformer model for journey simulation and prediction. In embodiments described herein, training data is obtained from stored journeys. The training data for each journey indicates customer interactions with each event in the sequence of events of the journey. A machine learning model is trained using the training data to simulate customer interaction with an input journey. The trained machine learning model then generates a simulation of customer interaction with an input journey and the results of the simulation are displayed.

### BACKGROUND

A customer journey refers to a series of interactions a customer has with a company across various channels over time. Business or marketers can design customer journeys to create targeted, personalized advertising campaigns for customers based on specific interactions with the customer, thereby improving customer engagement and conversion rates. In order to design a journey, the business/marketer must manually design the journey, test the journey on actual customers for period of a few weeks or months, manually evaluate how the journey performs on the deployed customers, manually refine the journey, and iterate this manual process until the business/marketer is satisfied with the results of the journey. The slow, manual iteration process for implementing customer journeys greatly reduces the time-to-value for a journey offering.

### SUMMARY

Various aspects of the technology described herein are generally directed to systems, methods, and computer storage media for, among other things, a transformer model for journey simulation and prediction. In this regard, embodiments described herein facilitate the simulation of a customer journey and predicting events of a simulated customer journey through a trained transformer model. For example, a transformer-based machine learning model is trained using training data obtained from stored customer journeys. The training data for the stored customer journeys indicates customer interactions with each event in the sequence of events of the journeys. A new customer journey is then input into the trained transformer-based machine learning model. The trained transformer-based machine learning model then simulates the journey by determining the probability of customers triggering (e.g., interacting with) events of the journey and/or predicting an event for a customer based on the sequence of events of the input customer journey. The user (e.g., business or marketer) can then use the simulation to assess the input journey without having to test the journey on actual customers for extended periods of time.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIGS. 3A and 3B provide example diagrams of a transformer model for journey simulation and prediction, in accordance with embodiments of the present disclosure.

FIG. 4 provides an example diagram of an architecture for implementing a transformer model for journey simulation and prediction, in accordance with embodiments of the present disclosure.

FIG. 5 provides an example diagram of user interface with a journey for journey simulation and prediction, in accordance with embodiments of the present disclosure.

FIG. 6 provides an example Sankey diagram of a journey simulation for a journey through a transformer model, in accordance with embodiments of the present disclosure.

FIG. 7 is a process flow showing a method for implementing a transformer model for journey simulation and prediction, in accordance with embodiments of the present disclosure.

FIG. 8 is a process flow showing a method for implementing a transformer model for journey simulation, in accordance with embodiments of the present disclosure.

FIG. 9 is a process flow showing a method for implementing a transformer model for journey event prediction, in accordance with embodiments of the present disclosure.

FIG. 10 is a block diagram of an example computing device in which embodiments of the present disclosure can be employed.

### DETAILED DESCRIPTION

### Definitions

Various terms are used throughout the description of embodiments provided herein. A brief overview of such terms and phrases is provided here for ease of understanding, but more details of these terms and phrases is provided throughout.

A “journey” or “customer journey” refers to a series or sequence of interactions between a customer and a business over time. Journeys occur over various channels, such as e-mail, phone calls/texting, social media, websites, physical locations, and any channel in which a customer and business interact. A journey can include a set of one or more events, conditions, and/or corresponding actions (e.g., responses). To this end, a journey can include a sequence of events, conditions, and/or actions (e.g., responses) through which customers may traverse. Journeys can be designed by users, such as marketers or businesses, to meet the goals of the business, such as to obtain new customers, develop leads, increase conversions, and increase loyalty. Journeys can be designed with various paths based on customer interactions, behavior, preferences, customer demographics, etc.

An “event” refers to an interaction of a customer with a business or that a business performs on behalf of a customer. Examples of events include selecting or clicking on a particular product, purchasing a particular product, navigating to a particular website, opening an e-mail, clicking a link, contacting customer service, entering and/or existing a retail brick-and-mortar store, and the like. Events can be used in journeys to trigger certain actions by the business, such as automated messaging. An event can be represented as a JavaScript Object Notation (“JSON”) with nested fields corresponding to data regarding each event. The events can include fields, such as time of the interaction, price of the product, location data for the customer (e.g., latitude and longitude, IP address, physical store address, etc.), website address for the web page visited by the customer, product type, or any data that a business/marketer includes in an event of a journey. Further, in some embodiments, the events can include fields related to customer demographic information and can include the customer's geographical location, economic status, customer gender, customer age, or any other relevant demographic data collected regarding the customer.

A “condition” refers to a rule or set of rules that are evaluated based on certain events and/or customer data and are used to determine next interactions in a journey. Examples of conditions can include customer demographics, customer behavior, time elapsed, etc. For example, a customer may abandon an online cart and a business may set a condition to send a communication regarding the abandoned cart after a period of time.

An “action” (e.g., response) refers to a specific response triggered by an event or conditions within a journey. Actions are used to automate personalized customer journeys by taking specific steps for specific customers when customers perform certain interactions (e.g., an event occurs) or certain conditions are met for the customer. Examples of actions include sending an e-mail, displaying a message on a website, updating a customer record/profile, or any action that a business takes with respect to its customer or potential customer. Following an action, an event can occur when the customer interacts with action generated by the business.

A “transformer-based machine learning model” or “transformer model” refers to a deep learning architecture primarily used for natural language processing (“NLP”). Transformers use a self-attention mechanism to capture context and dependencies in NLP.

An “embedding layer” refers to a type of layer in a neural network that maps certain data, such as words, to corresponding vector representations, which are referred to as embeddings.

A “transformer encoder layer” refers to an encoder layer of a transformer model. The encoder layer includes a self-attention sublayer which is responsive for determining attention weights that determine the importance or weight of each token of a sequence of tokens in order to determine sequential context of each token in the sequence of tokens.

A “positional embedding” is a type of embedding that captures the positional information of each element in the sequence and can be used to determine attention weights in order to determine sequential context.

### Overview

A customer journey refers to a series of interactions a customer has with a company across various channels over time. For example, these interactions (e.g., events) can include website/mobile application visits, clicking an advertisement, social media interactions, email communications, such as opening an e-mail, visiting a physical store or location, adding an item to an online cart, abandoning a cart, downloading a product for a free trial, checking out and purchasing the item, requesting help, or any interaction a customer initiates with a business. Business or marketers can design customer journeys to create targeted, personalized advertising campaigns for customers based on specific actions taken by the customer, thereby improving customer engagement and conversion rates. The customer journey designed by the business/marketer can include interactions with the customer (e.g., actions or responses) in response to interactions by the customer (e.g., events). For example these interactions (e.g., actions or responses) by the business can include personalizing the customer's experience based on the customer's data, targeting advertisements, sending email communications to the customer, sending follow-up email communications to the customer, initiating a phone call with the customer, sending confirmation email of a product purchase, requesting a product review, cross-selling other products, sending a communication regarding an abandoned cart with or without discounts, or any other interaction a business/marketer desires in response to a customer's interaction with the business.

The interactions between the business and a customer during a customer journey creates a distinctive customer journey experience. A distinctive customer journey experience increases the likelihood that customer will repeat a purchase with a business, spend more with the business, recommend the business or product to others, and maintain loyalty to the business. In order to design a journey, the business/marketer must manually design the journey, test the journey on actual customers for period of a few weeks or months, manually evaluate how the journey performs on the deployed customers, manually refine the journey, and iterate this manual process until the business/marketer is satisfied with the results of the journey. The slow, manual iteration process for implementing customer journeys greatly reduces the time-to-value for a journey offering.

Currently, there is an absence of a tool to simulate performance of a journey before the journey is launched. For instance, for a business/marketer who has designed a particular journey, there is currently no way to estimate how many customers will enter that journey. Further, there is no way to determine whether customers will interact with the actions taken by the business/marketer. Therefore, to estimate the overall efficiency, effectiveness, and performance of a journey the marketer today relies on heuristic knowledge gained by trial and error and manual testing. For instance, businesses often deploy the designed journey to a subset of the entire user base. The businesses then evaluate how the journey performs on the deployed customers. This evaluation gives the business an estimate of how the journey is likely to perform on the entire audience. In this process, if the business subjectively feels that a particular branch of the journey is not visited by a significant fraction of customers, then the business will manually make changes to that branch and repeat the process. Therefore, it can take several weeks or months before the business iterates to the final version of the journey. This slow iteration process greatly reduces the time-to-value for a journey offering.

Accordingly, unnecessary computing resources are utilized to manually implement customer journeys in conventional implementations. For example, computing and network resources are unnecessarily consumed to facilitate each manually-intensive iteration of the design, testing on actual customers, and re-design of the journey in conventional journey testing. For instance, computer input/output operations are unnecessarily increased in order to implement the journey on actual customers for an extended period of time as the business manually evaluates the journey. Further, computing resources are unnecessarily used to repeat the process for multiple iterations in order to manually refine the journey and re-test the refined journey on actual customers. Not only does the testing of the journey on actual customers cost a significant amount of time for the business, but the testing of the journey on actual customers is computationally expensive and increases latency. For example, each time an actual customer interacts with an event and the data regarding the event is located in a disk array, there is unnecessary wear placed on the read/write head of the disk of the disk array as the journey must be implemented for multiple iterations and for extended periods of time. Further, the manual testing of the journey on actual customers decreases the throughput for a network, increases the network latency, and increases packet generation costs as the journey must be implemented for actual customers over the network for multiple iterations and for extended periods of time.

As such, embodiments of the present disclosure are directed to a transformer model for journey simulation and prediction in an efficient and effective manner. In this regard, embodiments described herein facilitate the simulation of a customer journey and predicting events of a simulated customer journey through a trained transformer model. For example, a transformer-based machine learning model is trained using training data obtained from stored customer journeys. The training data for the stored customer journeys indicates customer interactions with each event in the sequence of events of the journeys. A new customer journey is then input into the trained transformer-based machine learning model. The trained transformer-based machine learning model then simulates the journey by determining the probability of customers triggering (e.g., interacting with) events of the journey and/or predicting an event for a customer based on the sequence of events of the input customer journey. The user (e.g., business or marketer) can then use the simulation to assess the input journey without having to test the journey on actual customers for extended periods of time.

In operation, as described herein, training data from previous customer journeys is obtained. The training data for the stored customer journeys indicates customer interactions with each event in the sequence of events of the journey. The training data of each event can include data corresponding to the type of event, the time of the event, the location of the customer, the website address that the customer interacted with, the product type, the product price, or any other data regarding the customer interaction with the event of the journey. Further, the training data can include customer data, such as customer profiles, customer demographic data (e.g., customer's geographical location, economic status, customer gender, customer age, or any other relevant demographic data collected regarding the customer), or any data regarding customers.

A transformer-based machine learning model is trained using training data obtained from stored customer journeys to simulate customer interaction with an input journey comprising an input sequence of events. The model can be trained by training an embedding layer to generate an embedding for each event in the input sequence of events of the input journey and training a transformer encoder layer to generate a positional embedding for each embedding of each event in the input sequence of events of the input journey. The embedding layer can include any amount of features regarding the events or the customers. The transformer encoder layer can be trained to use any amount of features from the embedding to generate the positional embedding for each embedding of each event in the input sequence of events of the input journey. The positional embedding provides sequential context and can attribute the importance of events in the sequence of events of the journey.

A new customer journey is then input into the trained transformer-based machine learning model to generate a simulation of the input customer journey. The simulation of the customer journey can be generated through the trained embedding layer, which generates an embedding for each event of the sequence of events, and a trained transformer encoder layer, which generates a positional embedding for each embedding of each event in the input sequence of events of the input journey. The trained transformer-based machine learning model then simulates the journey by determining the probability of customers triggering (e.g., interacting with) events of the journey and/or predicting an event for a customer based on the sequence of events of the input customer journey. The positional embedding can be utilized to provide sequential context (e.g., attention weights) so that the user (e.g., business or marketer) can understand the importance of certain events of the journey.

Thus, the model can provide a simulation of how the journey would pan out when actually deployed without having to deploy the journey for actual customer for extended periods of time. The model provides the capability to identify and pre-empt potential problems across various stages of the journey by providing a model that generates insights regarding sequential context of a sequence of events of a journey, thereby resulting in a significant reduction in the time-to-value of implementing a successful journey.

Advantageously, efficiencies of computing and network resources can be enhanced using implementations described herein. In particular, the simulation of a customer journey and predicting events of a simulated customer journey through a trained transformer model provides for a more efficient use of computing resources (e.g., less computationally expensive, less input/output operations, higher throughput and reduced latency for a network, less packet generation costs, etc.) than conventional methods that require the manually-intensive process of the design, testing on actual customers, and re-design of the journey for multiple iterations. In this regard, the technology described herein enables a user to be able to efficiently and effectively simulate a customer journey through a trained transformer model, thereby reducing unnecessary computing resources used to manually implementing journeys to test the journey on actual customer for multiple iterations and for extended periods of time. The technology described herein conserves network resources as the technology results in less accesses of data over a computer network as the technology does not require the testing of the journey of actual customers over the network for multiple iterations and for extended periods of time, which results in higher throughput, reduced latency and less packet generation costs as fewer packets are sent over the network.

### Overview of Exemplary Environments of a Transformer Model for Journey Simulation and Prediction

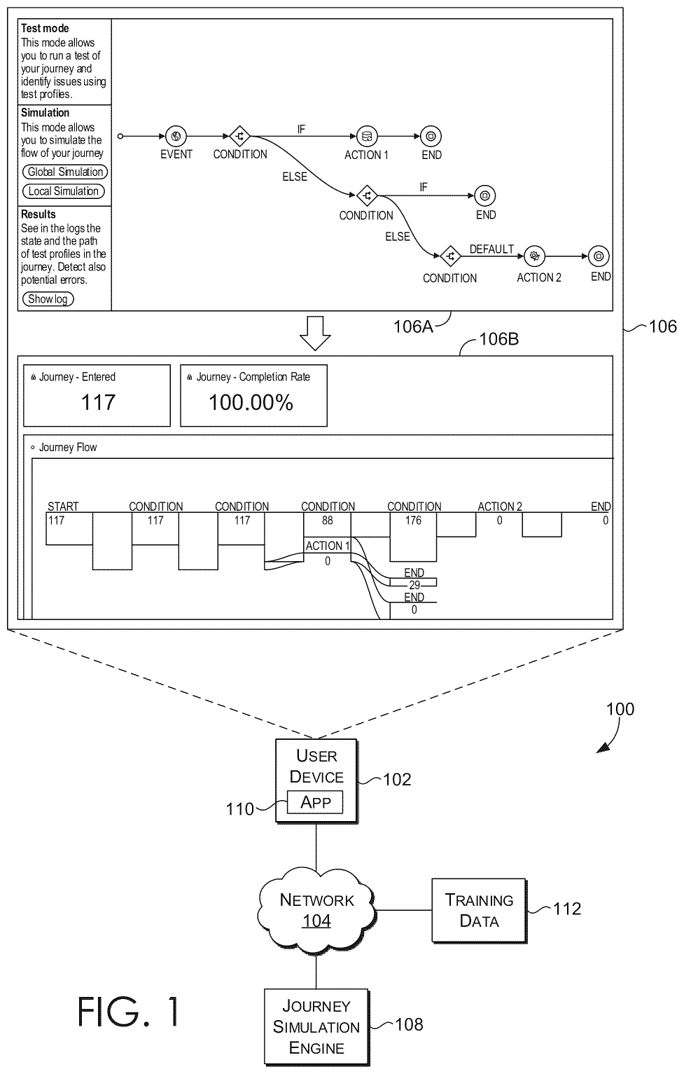

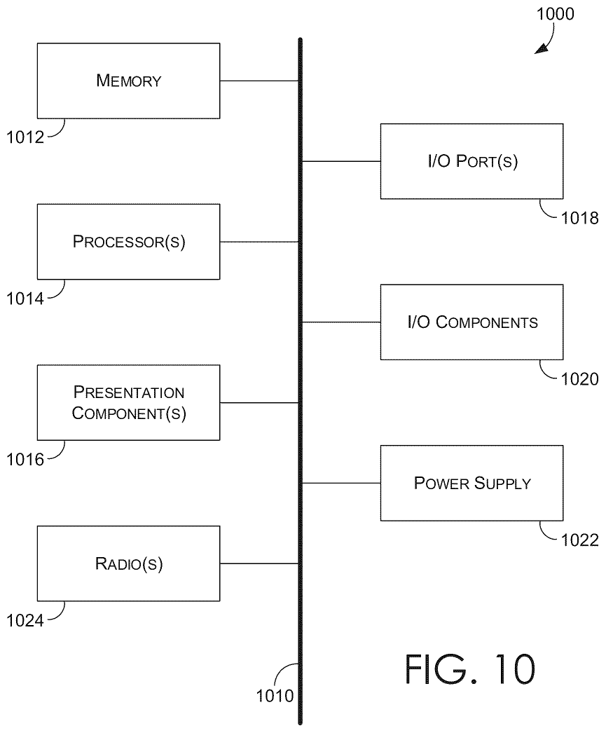

Turning to the figures, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 10.

It should be understood that operating environment 100 shown in FIG. 1 is an example of one suitable operating environment. Among other components not shown, operating environment 100 includes a user device 102, application 110, network 104, and journey simulation engine 108. Operating environment 100 also shows training data 112 to train journey simulation engine 108. Operating environment 100 also shows an example of journey simulation and prediction using a transformer model shown as example 106. Example 106 includes an example input journey 106A and an example simulation of the input journey 106B. Each of the components shown in FIG. 1 can be implemented via any type of computing device, such as one or more of computing device 1000 described in connection to FIG. 10, for example.

These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual(s) (e.g., a marketer or business designing customer journeys). For example, in some implementations, such devices are the type of computing device described in relation to FIG. 10. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media may include computer-readable instructions executable by the one or more processors. The instructions may be embodied by one or more applications, such as application 110 shown in FIG. 1. Application 110 is referred to as single applications for simplicity, but its functionality can be embodied by one or more applications in practice.

Application 110 operating on user device 102 can generally be any application capable of designing customer journeys. In some implementations, the application 110 comprises a web application, which can run in a web browser, and could be hosted at least partially server-side (e.g., via journey simulation engine 108). In addition, or instead, the application 110 can comprise a dedicated application. In some cases, the application 110 is integrated into the operating system (e.g., as a service). As specific example applications, application 110 may be a customer journey management website or application or any website or application that is capable of designing customer journeys. Such an application may be accessed via a mobile application, a web application, or the like.

User device 102 can be a client device on a client-side of operating environment 100, while journey simulation engine 108 can be on a server-side of operating environment 100. Journey simulation engine 108 may comprise server-side software designed to work in conjunction with client-side software on user device 102 so as to implement any combination of the features and functionalities discussed in the present disclosure. An example of such client-side software is application 110 on user device 102. This division of operating environment 100 is provided to illustrate one example of a suitable environment, and it is noted there is no requirement for each implementation that any combination of user device 102 or journey simulation engine 108 to remain as separate entities.

Application 110 operating on user device 102 can generally be any application capable of facilitating the exchange of information between the user device 102 and the journey simulation engine 108 in displaying and exchanging information regarding customer journeys. In some implementations, the application 110 comprises a web application, which can run in a web browser, and could be hosted at least partially on the server-side of environment 100. In addition, or instead, the application 110 can comprise a dedicated application. In some cases, the application 110 is integrated into the operating system (e.g., as a service). It is therefore contemplated herein that “application” be interpreted broadly.

In accordance with embodiments herein, the application 110 can facilitate a transformer model for journey simulation and prediction in an efficient and effective manner. An example of journey simulation and prediction using a transformer model is shown as example 106.

In operation, a new customer journey is input and displayed via a graphical user interface provided via the application 110. For example, example 106 includes an example input journey 106A. As can be appreciated, example input journey 106A includes an event that triggers actions based on certain conditions. In this regard, the conditions trigger certain events, which in turn trigger certain actions in the journey. The user (e.g., marketer or business) selects a simulation option to simulate the input journey. In example input journey 106A, the user selects the “Global Simulation” option to simulate the input journey.

Journey simulation engine 108 generates a simulation of customer interaction with the input customer journey through the trained transformer-based machine learning model of journey simulation engine 108. The simulation of customer interaction with the input customer journey is displayed through application 110. For example, example 106 includes an example simulation 106B of customer interaction with the example input journey 106A. As can be appreciated from example simulation 106B, a certain subset of simulated customers enter the journey and certain conditions are completed by the simulated customers (e.g., events) to determine whether certain actions occur. Thus, journey simulation engine 108 predicts a probability of customers triggering (e.g., interacting with) events of the input sequence of events of the input journey.

The transformer-based machine learning model of journey simulation engine 108 is trained using training data 112 obtained from stored customer journeys to simulate customer interaction with an input journey. Training data 112 can include data regarding stored customer journeys indicates customer interactions with each event in the sequence of events of the journey. For example, training data 112 can include data for events corresponding to the type of event, the time of the event, the location of the customer, the website address that the customer interacted with, the product type, the product price, or any other data regarding the customer interaction with the event of the journey. Further, training data 112 can include customer data, such as customer profiles, customer demographic data (e.g., customer's geographical location, economic status, customer gender, customer age, or any other relevant demographic data collected regarding the customer), or any data regarding customers.

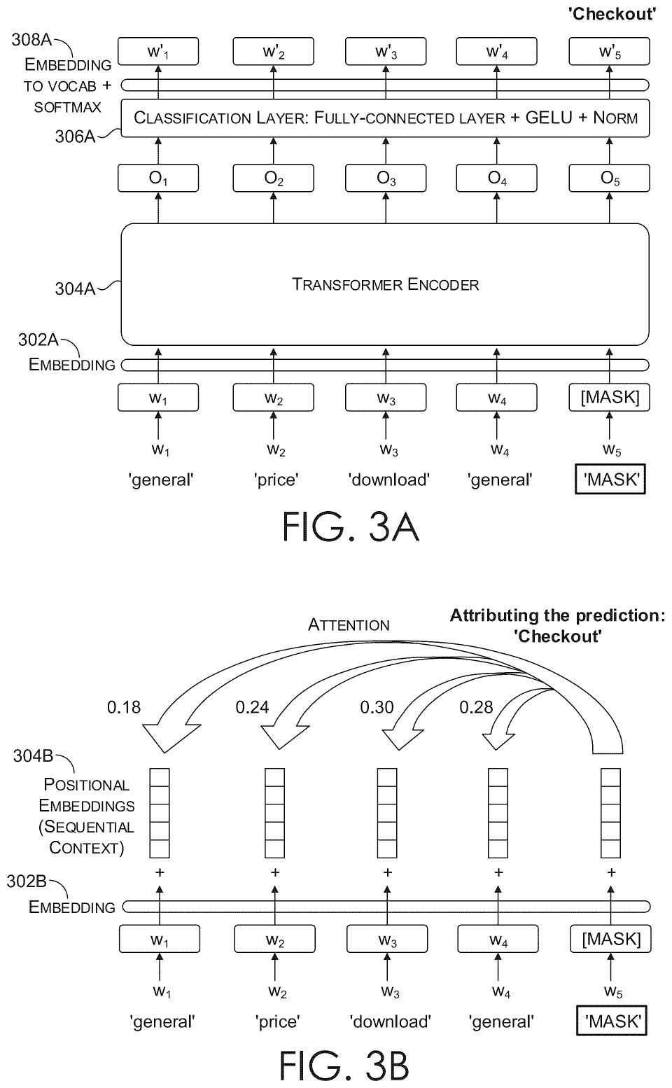

As discussed in further detail with respect to FIGS. 3A and 3B below, in certain embodiments, the transformer-based machine learning model of journey simulation engine 108 can be trained by training an embedding layer to generate an embedding for each event in the input sequence of events of the input journey and training a transformer encoder layer to generate a positional embedding for each embedding of each event in the input sequence of events of the input journey. The embedding layer can include any amount of features regarding the events or the customers. The transformer encoder layer can be trained to use any amount of features from the embedding to generate the positional embedding for each embedding of each event in the input sequence of events of the input journey.

As discussed in further detail with respect to FIGS. 3A and 3B below, in certain embodiments, journey simulation engine 108 generates a simulation of customer interaction with the input customer journey through a trained embedding layer, which generates an embedding for each event of the sequence of events, and a trained transformer encoder layer, which generates a positional embedding for each embedding of each event in the input sequence of events of the input journey. The trained transformer-based machine learning model of journey simulation engine 108 then simulates the journey by determining the probability of customers triggering (e.g., interacting with) events of the journey and/or predicting an event for a customer based on the sequence of events of the input customer journey. The positional embedding can be utilized to provide sequential context (e.g., attention weights) so that the user (e.g., business or marketer) can understand the importance of certain events of the journey.

At a high level, journey simulation engine 108 performs various functionality to facilitate efficient and effective journey simulation and event prediction using a transformer model. The journey simulation engine 108 can communicate with application 110 in order for application 110 to display the input journey and output results of the via a display screen of the user device 102.

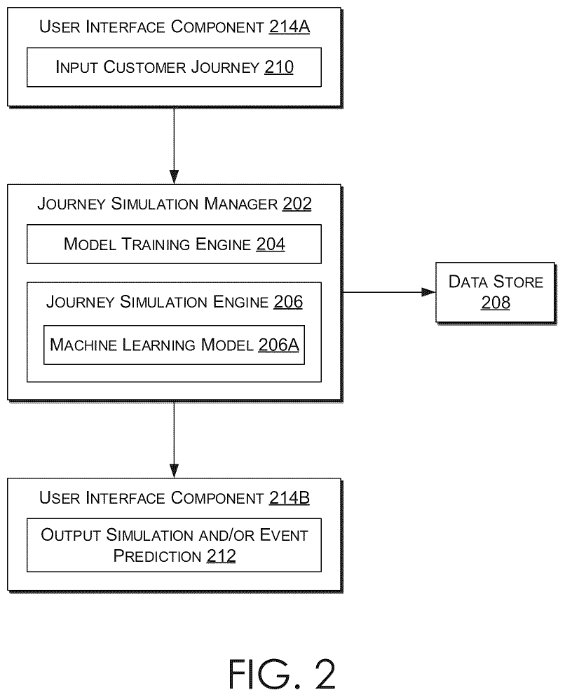

In this regard, journey simulation engine 108 can receive data regarding the input journey from application 110 of the user device. Further, journey simulation engine 108 can receive training data and customer data from training data 112 and/or application 110 of the user device. Journey simulation engine 108 can generate a simulation of the input journey and communicate results of the simulation to application 110 for display in the user device. Journey simulation engine 108 can be or include a server, including one or more processors, and one or more computer-readable media. The computer-readable media includes computer-readable instructions executable by the one or more processors. The instructions can optionally implement one or more components of journey simulation engine 108, described in additional detail below with respect to journey simulation manager 202 of FIG. 2.

For cloud-based implementations, the instructions on journey simulation engine 108 can implement one or more components, and application 110 can be utilized by a user to interface with the functionality implemented on journey simulation engine 108. In some cases, application 110 comprises a web browser. In other cases, journey simulation engine 108 may not be required. For example, the components of journey simulation engine 108 may be implemented completely on a user device, such as user device 102. In this case, journey simulation engine 108 may be embodied at least partially by the instructions corresponding to application 110.

Thus, it should be appreciated that journey simulation engine 108 may be provided via multiple devices arranged in a distributed environment that collectively provide the functionality described herein. Additionally, other components not shown may also be included within the distributed environment. In addition, or instead, journey simulation engine 108 can be integrated, at least partially, into a user device, such as user device 102. Furthermore, journey simulation engine 108 may at least partially be embodied as a cloud computing service.

Referring to FIG. 2, aspects of an illustrative journey simulation management system are shown, in accordance with various embodiments of the present disclosure. At a high level, the journey simulation management system can train a machine learning model to simulate customer interaction with an input journey and generate a simulation of customer interaction with the input journey and/or event prediction for the input journey.

As shown in FIG. 2, journey simulation manager 202 includes a model training engine 204 and a journey simulation engine 206. Input customer journey 210 is input into journey simulation manager 202 through user interface component 214A and journey simulation manager 202 outputs output simulation and/or event prediction 212 for presentation through user interface component 214B. The journey simulation manager 202 can communicate with the data store 208. The data store 208 is configured to store various types of information accessible by journey simulation manager 202, or other server or component. The foregoing components of journey simulation manager 202 can be implemented, for example, in operating environment 100 of FIG. 1. In particular, those components may be integrated into any suitable combination of user devices 102 and/or journey simulation engine 108. In this regard, user interface components 214A/214B can be any type of user interface (e.g., a graphical user interface provided via the application 110 of user device 102). In embodiments, user interface components 214A/214B can be the same user interface so that a user can input the customer journey 210 and receive the output simulation and/or event prediction 212 for display in the same user interface. In other embodiments, user interface components 214A/214B are different user interfaces in that the input the customer journey 210 is input through one user interface and the output simulation and/or event prediction 212 is displayed in a different user interface.

In embodiments, data sources (such as input customer journey 210 and output simulation and/or event prediction 212), user devices (such as user device 102 of FIG. 1 and user interface components 214A/214B), and journey simulation manager 202 can provide data to the data store 208 for storage, which may be retrieved or referenced by any such component. As such, the data store 208 can store computer instructions (e.g., software program instructions, routines, or services), data and/or models used in embodiments described herein, such as transformer models for simulating a customer journey, customer journeys with events, actions and conditions as training data, simulated customer journeys, customer data for training and simulating customer journeys, and/or the like. In some implementations, data store 208 can store information or data received or generated via the various components of journey simulation manager 202 and provides the various components with access to that information or data, as needed. The information in data store 208 may be distributed in any suitable manner across one or more data stores for storage (which may be hosted externally).

The model training engine 204 is generally configured to train a machine learning model to simulate customer interaction with an input journey. In embodiments, model training engine 204 can include rules, conditions, associations, models, algorithms, or the like to train a machine learning model to simulate customer interaction with an input journey. Model training engine 204 may take on different forms depending on the mechanism used to train a machine learning model to simulate customer interaction with an input journey. For example, model training engine 204 may comprise natural language processing techniques, a statistical model, fuzzy logic, neural network, finite state machine, support vector machine, logistic regression, clustering, or machine-learning techniques, similar statistical classification processes, or combinations of these to train a machine learning model to simulate customer interaction with an input journey.

In embodiments, model training engine 204 trains a machine learning model 206A of journey simulation engine 206. In certain embodiments, model training engine 204 trains the machine learning model 206A of journey simulation engine 206 as a transformer-based machine learning model. An example of the transformer-based machine learning model is provided in FIGS. 3A and 3B and discussed in further detail below. Generally, and at a high-level, model training engine 204 obtains training data from previous customer journeys stored in data store 208. The training data for the stored customer journeys indicates customer interactions with each event in the sequence of events of the journey. The training data of each event can include data corresponding to the type of event, the time of the event, the location of the customer, the website address that the customer interacted with, the product type, the product price, or any other data regarding the customer interaction with the event of the journey. Further, the training data can include customer data, such as customer profiles, customer demographic data (e.g., customer's geographical location, economic status, customer gender, customer age, or any other relevant demographic data collected regarding the customer), or any data regarding customers.

Model training engine 204 trains a machine learning model 206A of journey simulation engine 206 (e.g., as a transformer-based machine learning model) using training data obtained from stored customer journeys stored in data store 208 to simulate customer interaction with an input journey. Model training engine 204 can train the machine learning model 206A of journey simulation engine 206 as a transformer-based machine learning model by training an embedding layer of machine learning model 206A to generate an embedding for each event in the input sequence of events of the input journey and training a transformer encoder layer of machine learning model 206A to generate a positional embedding for each embedding of each event in the input sequence of events of the input journey. The embedding layer of machine learning model 206A can include any amount of features regarding the events or the customers. The transformer encoder layer of machine learning model 206A can be trained to use any amount of features from the embedding to generate the positional embedding for each embedding of each event in the input sequence of events of the input journey. The positional embedding generated by machine learning model 206A provides sequential context (e.g., attention weights) and can attribute the importance of events in the sequence of events of the journey.

The journey simulation engine 206 is generally configured to generate a simulation of customer interaction with the input journey. Journey simulation engine 206 can include rules, conditions, associations, models, algorithms, or the like to generate a simulation of customer interaction with the input journey. Journey simulation engine 206 may take on different forms depending on the mechanism used generate a simulation of customer interaction with the input journey. For example, journey simulation engine 206 may comprise a natural language processing techniques, statistical model, fuzzy logic, neural network, finite state machine, support vector machine, logistic regression, clustering, or machine-learning techniques, similar statistical classification processes, or combinations of these to generate a simulation of customer interaction with the input journey.

In embodiments, journey simulation engine 206 includes a machine learning model 206A trained to generate a simulation of the input customer journey. In embodiments, machine learning model 206A is a transformer-based machine learning model. An example of the transformer-based machine learning model is provided in FIGS. 3A and 3B and discussed in further detail below. Generally, and at a high-level, journey simulation engine 206 receives an input customer journey and generates a simulation and/or predicts events based on the input customer journey. For example, journey simulation engine 206 receives input customer journey 210 from user interface component 214A and outputs output simulation and/or event prediction 212 to user interface component 214B. Embodiments describing how journey simulation engine 206 outputs output simulation and/or event prediction 212 are described in further detail with respect to FIGS. 3A-6 below.

In some embodiments, journey simulation engine 206 generates the simulation of the customer journey through a trained embedding layer of machine learning model 206A, which generates an embedding for each event of the sequence of events, and a trained transformer encoder layer of machine learning model 206A, which generates a positional embedding for each embedding of each event in the input sequence of events of the input journey. Machine learning model 206A then simulates the journey by determining the probability of customers triggering (e.g., interacting with) events of the journey and/or predicting an event for a customer based on the sequence of events of the input customer journey. The positional embedding generated by machine learning model 206A can be utilized to provide sequential context (e.g., attention weights) so that the user (e.g., business or marketer) can understand the importance of certain events of the journey.

FIGS. 3A and 3B provide example diagrams of a transformer model for journey simulation and prediction, in accordance with embodiments of the present disclosure. At a high level, given a user journey—{e₁, e₂, e₃, . . . , eₙ}, the transformer model takes as input the ordered sequence of event ids in the user journey—{e₁, e₂, e₃, . . . , eₙ₋₁} and is trained to predict the n^{th} event eₙ given the previous n−1 events as input context, where n is a variable. FIGS. 3A and 3B shows a high-level schematic diagram depicting an example workflow of a customer journey. In the example shown in FIGS. 3A and 3B, the customer journey includes the following sequence of events—{‘general’, ‘price’, ‘download’, ‘general’, ‘Checkout’}. The event ‘general’ can correspond to the customer taking a general action, such as visiting a web page. The event ‘price’ can correspond to the price for the product being presented to the customer. The event ‘download’ can correspond to the user downloading a free trial version of the product. The event ‘checkout’ can correspond to the user purchasing the product.

In the example shown in FIGS. 3A and 3B, the last event in the journey ‘Checkout’ is replaced with a ‘MASK’ token during training. In this regard, the sequence of events-{‘general’, ‘price’, ‘download’, ‘general’, ‘MASK’} is given as input. During training and simulation, the events can be input as JSONs with nested fields corresponding to data regarding each event. The events can include fields, such as time of the interaction, price of the product, location data for the customer (e.g., latitude and longitude, IP address, physical store address, etc.), website address for the web page visited by the customer, product type, or any data that a business/marketer includes in an event of a journey. Further, in some embodiments, the events can include fields related to customer demographic information and can include the customer's geographical location, economic status, customer gender, customer age, or any other relevant demographic data collected regarding the customer. In some embodiments, the JSONs, or portions of the JSONs of the events (e.g., event name, etc.), can be converted into plain language before being input into the model.

The model embeds each event in the sequence corresponding to the event ID/token (e.g., such as the event names shown: ‘general’, ‘price’, ‘download’, ‘general’, ‘Checkout’) using a trained embedding layer 302A which learns a unique embedding for each event ID/token. The embedding layer gets optimized along with rest of the learnable parameters of the model during training. In embodiments, the data of the events, such as fields of JSONs, can be chunked or tokenized based on features of the event and included as a part of the embedding for each event. Further, the JSONs can be chunked or tokenized by the embedding layer based on the features of the JSON that are learned based on the structure of the journey.

Following the embedding layer, the embedding for each event proceeds to the transformer encoder layer 304A. The transformer encoder layer 304A includes one or more attention layers where the model iteratively updates the representations of each event in the ordered sequence by factoring in representations of other events in the journey to capture the sequential context (e.g., attention weights).

An example of the sequential context, or positional embeddings, as determined by the transformer encoder layer 304A are shown in FIG. 3B. As shown in FIG. 3B, positional embeddings 304B determined by the transformer encoder layer (shown in FIG. 3A as 304A), which provides sequential context (e.g., attention weights) for each of the events in the prediction by the transformer model. The positional embeddings 304B can be determined by the transformer encoder layer (shown in FIG. 3A as 304A) following output of the embeddings by embedding layer 302B (also shown in FIG. 3A as 302A). To capture the sequential ordering and context of events in a given user journey sequence, a positional embedding is computed for each event in the sequence which is added to the embedded representation of the event ID learned through embedding layer. The positional embedding is estimated according to position of the event in the sequence and enables the model to capture the sequential dependencies based on relative ordering and positioning of the events. As shown in the example of FIG. 3B, the prediction of ‘Checkout’ event is attributed as 28% to the second ‘general’ event, 30% to ‘download’ event, 24% to ‘price’ event, and 18% to the first ‘general’ event. The attributed weights of each event for the event prediction can be displayed in a user interface to the user (such as the marketer or business designing the journey) so that the user can evaluate which events of the journey have the highest influence on the ‘Checkout’ event. In some embodiments, the attributed weights of each event for the event prediction can be displayed regarding a specific customer (or specific customers) and/or can be aggregated across all customers of the simulation.

In some embodiments, the model incorporates additional event data (e.g., timestamp of events, etc.) and customer data (e.g., profile attributes, demographics etc.). The associated feature vectors of the additional data can be concatenated or added to the event embeddings to obtain a better model enriched through additional information. Thus, positional embedding to events in the sequence enables model to effectively capture the events sequence and relative ordering for events with any number of fields.

Further, FIG. 3B provides attentions layers based on the transformer model (shown as transformer encoder layer 304A in FIG. 3A). The Transformer model obtains contextually rich representations for a given event by incorporating a weighted combination of representation of other events in the sequence through attention layers. For example, for an event ‘i’ in the sequence represented as eᵢ, after processing through embedding and positional encoding layers, an attention layer (or attention layers) computes a weight wⱼ (e.g., attention weights) for each other event j based on eᵢ and eⱼ. The weights (e.g., attention weights) are normalized over j such that their sum is 1. The weights are used to perform a weighted linear combination over the representations eⱼ while updating the representation of event i. Thus, the attention layer (or attention layers) help the model to decide which other events to focus to effectively capture the sequential context (e.g., attention weights) while updating the current representation of event i.

The linear combination can then be processed through fully connected layers to obtain the representation of event i. This is performed for each event in the sequence. The model can include multiple attention layers, where each attention layer includes multiple attention heads to capture multiple patterns. As a by-product of model's mechanism to capture sequential context, the attention weights can further be utilized to understand and attribute which other events in the user journey are important that led the model to predict the next events. FIG. 3B shows relative attention put on input events while predicting ‘Checkout’. After attention layers, we get an output for each event such that representations corresponding to ‘MASK’ token are used to predict the next event. In the example, the model is trained to increase the probability of predicting ‘Checkout’ as it was present (and masked at the input layer) in the ground truth sequence. Information regarding the attention weights can be displayed to the user in order to provide sequential context for each event in the sequence of events of the journey.

Turning back to FIG. 3A, the transformer encoder layer 304A outputs a contextually enriched representation for each event in the sequence such that the output corresponding to the input MASK token is then processed through a fully connected layer (shown as a part of classification layer 306A in FIG. 3A) to predict a probability distribution over the set of possible next user events. A fully connected layer 306A is a type of artificial neural network layer where all nodes of the layer are connected to all of the nodes of the previous layer. In the example shown in FIG. 3A, the fully connected layer takes the input features from the transformer encoder layer that include features capturing the sequential context (e.g., attention weights) of the input and applies a set of learned weights to them to a produce a new set of features. The new set of features are then passed through an activation function, such as the Guassian Error Linear Unite (“GELU”) activation function, which introduces non-linearity into the model. The Norm function can be used to prevent overfitting of the model to the training data.

The classification layer 306A takes the output of the fully connected layer and produces a probability distribution over the different classes in the dataset. The classification layer 306A may include softmax layer (shown as embedding to vocab+softmax layer 308A). Softmax layer takes the numerical values produced by the fully connected layer and converts them into a probability distribution over the classes (e.g., event embeddings/IDs/tokens). The class (e.g., event embedding/ID/token) with the highest probability is typically chosen as the predicted class (e.g., event embedding/ID/token) for the output. The embedding to vocab layer (shown as embedding to vocab+softmax layer 308A) can then map each event embedding/ID/token to the corresponding output event.

In some embodiments, the output event from embedding to vocab+softmax layer 308A can be the event name, such as ‘Checkout’ shown in the example. In some embodiments, the output event from embedding to vocab+softmax layer 308A can be JSONs with nested fields corresponding to data regarding the output event. The events can include fields, such as time of the interaction, price of the product, location data for the customer (e.g., latitude and longitude, IP address, physical store address, etc.), website address for the web page visited by the customer, product type, or any data that a business/marketer includes in an event of a journey. Further, in some embodiments, the events can include fields related to customer demographic information.

In some embodiments, in order to train the model to output events as JSONs with nested fields corresponding to data regarding the output event, the model is trained using multiple ordering of events. For example, given the training data with a sequence of events of {′A′, ‘B’, ‘C’, ‘D’, ‘E’}, the training data can utilize multiple training examples, such as {′A′, ‘B’, ‘C’, ‘D’, ‘E’}, {‘B’, ‘C’, ‘D’, ‘E’}, {C′, ‘D’, ‘E’}, etc. In this regard, the multiple training examples can be utilized to output additional data by the model as JSONs an include more data that would be output by single training example. In some embodiments, where events are stored in formats other than JSONs and the data format of the event includes additional fields, a similar approach may be utilized to train the model based on additional journey sequences.

In some embodiments, in order output events as JSONs with nested fields (or any data format for events that includes additional fields) corresponding to data regarding the output event, multiple ordering of events of a journey can be input into the model. For example, if the model fails to output a full JSON representing an event and only outputs a partial JSON for the output event for a input journey with a sequence of events of {′A′, ‘B’, ‘C’, ‘D’, ‘E’}, additional journeys based on the sequence of events of the input journey can be input into the model to obtain the remaining portion of the JSON. In this example, additional journeys based on the sequence of events of the input journey, such as {‘B’, ‘C’, ‘D’, ‘E’}, {′C′, ‘D’, ‘E’}, etc. can be input into the model to obtain the remaining portion of the JSON. In this regard, the additional sequences of events can be utilized to output additional data to obtain a full JSON to represent an output event. In some embodiments, where events are stored in formats other than JSONs and the data format of the event includes additional fields, a similar approach may be utilized to output the desired data file in the desired format based on additional journey sequences.

In the example shown in FIGS. 3A and 3B, the model is trained to increase the probability of predicting ‘Checkout’ as it was present in the ground truth sequence, but masked at the input layer. Once the model is trained, the model can use inference to predict the next event in a user journey, conditioned on the past events sequence. At a high level, to simulate longer user journeys requiring to predict more than one event, the model can be inferred iteratively by conditioning it on input sequence and predicted events. For example, given the input sequence {e₁, e₂, e₃, . . . , eₙ}, the model can be used to predict the next event pₙ₊₁. Subsequently, {e₁, e₂, e₃, . . . , pₙ₊₁} can be given as input to the model to make the second prediction. Thus, the model can be used to predict arbitrary number of events in the user journey.

As can be appreciated, in some embodiments, the model can predict predefined events (e.g., ‘Checkout’). In some embodiments, the model can predict new (e.g., not predefined) events and/or predefined events with changes to certain fields of the event.

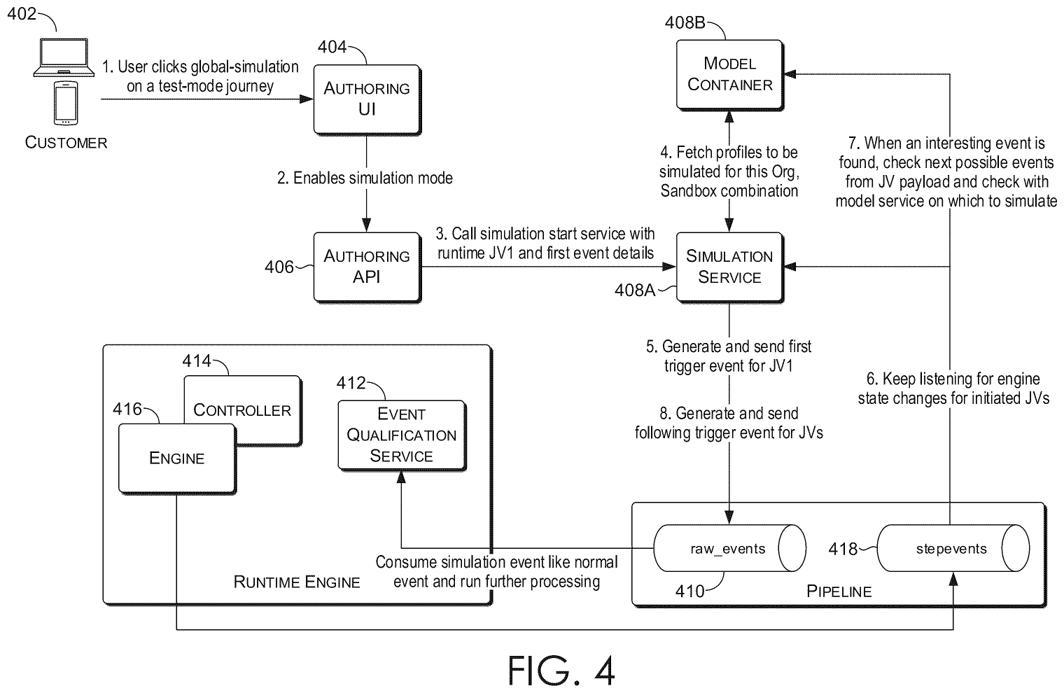

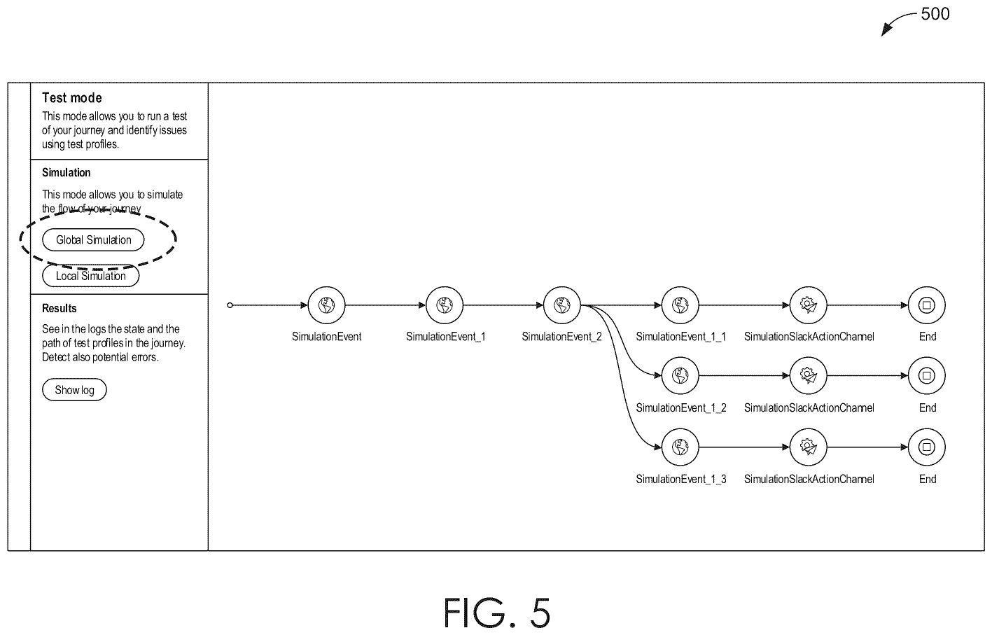

FIG. 4 provides an example diagram of an architecture for implementing a transformer model for journey simulation and prediction, in accordance with embodiments of the present disclosure. FIG. 5 provides an example user interface with a journey for journey simulation and prediction, in accordance with embodiments of the present disclosure. As shown in FIGS. 4 and 5, a user, such as a business/marketer that desires to simulate a customer journey, can design a customer journey in a user interface (“UI”) shown in FIG. 5.

An example of a customer journey for simulation is shown in FIG. 5. As can be appreciated from the example shown in FIG. 5, the journey includes any number of events (labeled as SimulationEvent, SimulationEvent_1, SimulationEvent_2, SimulationEvent_1_1, SimulationEvent_1_2, and SimulationEvent_1_3). Further, the journey shown in FIG. 5 shows any number of actions in response to the events or conditions (labeled as SimulationSlackActionChannel). Following the implementation of the Action, the Journey ends at the respective endpoints (labeled as End). In the example journey shown in FIG. 5, the events, conditions, and actions correspond to JSONs with various nested field corresponding to data regarding the events, conditions, and actions.

As shown in FIG. 5, in the UI, the user can select “Global Simulation” to simulate the entire journey, “Local Simulation” to simulate portions of the journey, and “Show Log” to see results of the journey. With brief reference to FIG. 1, an example of results of the journey shown in a UI upon clicking “show log” is shown in 106B. Turning back to FIGS. 4 and 5, a user can select “Global Simulation” in the UI of FIG. 5 to simulate the journey. The example journey shown in FIG. 5 can be simulated using the example architecture of FIG. 4.

As shown in FIG. 4, the user 402 selects “Global Simulation” in a test mode of the journey and the authoring UI 404 enables simulation mode. The authoring application programming interface (“API”) 406 sends an API call to the simulation service 408A. The API call starts simulation service 408A and sends data regarding the first event of the journey. The simulation service 408A operates in a sandbox environment (e.g., in a testing environment that is separate from the production environment where journeys would be implanted on actual customers). The simulation service 408A fetches the profiles of the customers from the customer data of the business/organization from model container 408B. In this regard, the simulation service 408A can model the journey on the customers of the business based on the previous data of the customer's journeys and other customer data (e.g., customer demographic data) for the customers of the business. The simulation service 408A can be a transformer-based machine learning model trained on previous journeys of the customers stored in model container 408B.

Using the data from model contain 408B and the event details from authoring API 406, the simulation service 408A generates the first event payload for a set of customers (shown as JV1) and writes it to “raw_events” 410 to store the event payload in memory. Simulation service 408A generates the first event payload for a set of customers (shown as JV1) by determining the most likely interactions taken by the set of user retrieved from model container 408B with respect to the event details in the journey. The event qualification service 412 of the runtime engine reads the event payload, processes the event payload, and writes each event payload to controller 414 as a processed step event (e.g., the step event is referred to as a step event as the step event moves the journey to the next step of the journey as if a set of customers interacted with an event of the journey). Controller 414 sends the processed step events to engine 416, which then write/stores the processed step events on “stepevents” 418.

The processed step event stored in “stepevents” 418 is received by simulation service 408A. Simulation service 408A determines/predicts the next set of possible events (if there are any). In this regard, for each processed step event, simulation service 408A determines the next set of possible events, which can include: (a) no event: in this case the journey proceeds as usual and service waits for the next event/action based on the stored journey tree (e.g., sequence of events/actions of the journey) sent by authoring API 406; (b) single event: simulation service 408A writes the predicted single event to “raw_events” topic, which in turn becomes a processed step event, thereby repeating the process by simulation service 408A; and (c) multiple events: simulation service 408A sends the list of past events for every customer and the set of next possible events. Based on the past events, model predicts the event which is most likely to occur (out of the set of next possible events) simulating the actual real-world deployment. Model responds with one event and service writes it to “raw_events”. For example, the step event predicted by the simulation service 408A may be a different event than the next event. In this case, the simulation service 408A would proceed with the predicted step event before proceeding to the next event/action of the input journey.

In this regard, simulation service 408A generates the event payloads (JVs) for the whole journey tree (e.g., sequence of events/actions of the journey) for the set of customers and writes it to “raw_events” 410 to store the event payloads in memory. Simulation service 408A generates the event payloads (JVs) for the whole journey tree (e.g., sequence of events/actions of the journey) for the set of customers by determining the most likely interactions taken by the set of user retrieved from model container 408B with respect to the event details in the journey. The event qualification service 412 of the runtime engine reads the event payload, processes the event payload, and writes each event payload to controller 414 as a processed step. Controller 414 sends the processed step events to engine 416, which then write/stores the processed step events on “stepevents” 418.

The simulation service 408A continues to listen to the incoming step events until the last end node for all the customers are processed. This marks the end of simulation. The business/marketer can then view the results of the simulation in the UI. The results can include data regarding how many customers interacted with each event of the simulation and can include data regarding the predicted events taken by the customers in response to the journey. An example of a UI showing a simulation of journey is shown in example 106 of FIG. 1. Example 106 of FIG. 1 is shown for exemplary purposes only and the simulation can include any data described in the embodiments herein.

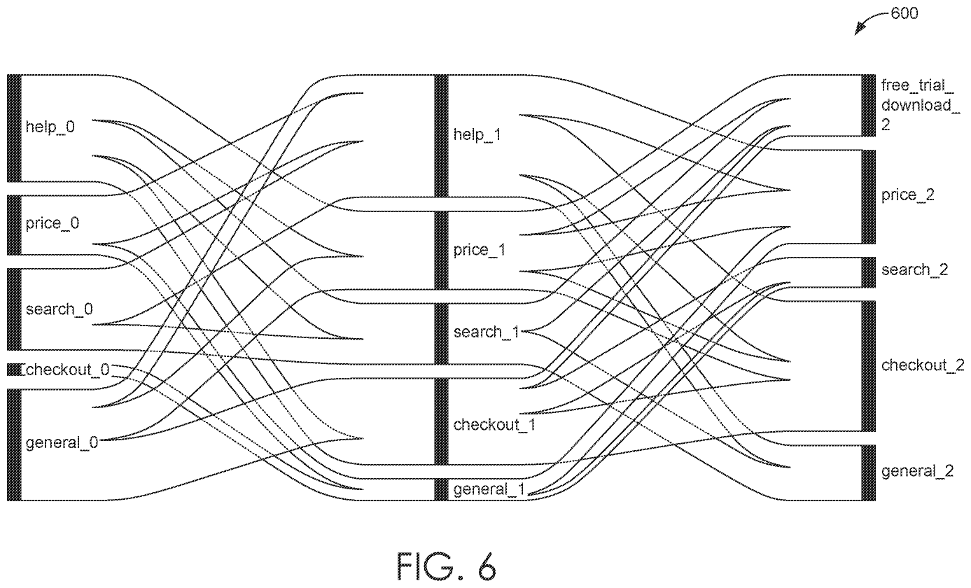

FIG. 6 provides an example Sankey diagram of a journey simulation for a journey through a transformer model, in accordance with embodiments of the present disclosure. As shown in FIG. 6, an example customer journey included the following events: [‘general’, ‘free_trial_download’, ‘general’, ‘help’, ‘free_trial_download’, ‘price’, ‘checkout’, ‘price’, ‘free_trial_download’, ‘checkout’]. The trained transformer model aggregates user journeys by sampling next user actions in a journey iteratively from the model predictions. The trained transformer model compute user transitions based statistics in a journey. The user transitions in the journey is visualized in the form of a Sankey diagram of FIG. 6. The Sankey diagram of FIG. 6 shows the user state evolution over time. Each vertical slice represents the states of the various customers at a single point in time. The customers can be in any of the states varying from Help to Download. The arrows connecting one state at one point in time to another point in time represent the number of customers that have transitioned from the source state to destination state. As can be appreciated, the transformer model is able to predict the interactions of the customer with the journey.

### Exemplary Implementations of a Transformer Model for Journey Simulation and Prediction

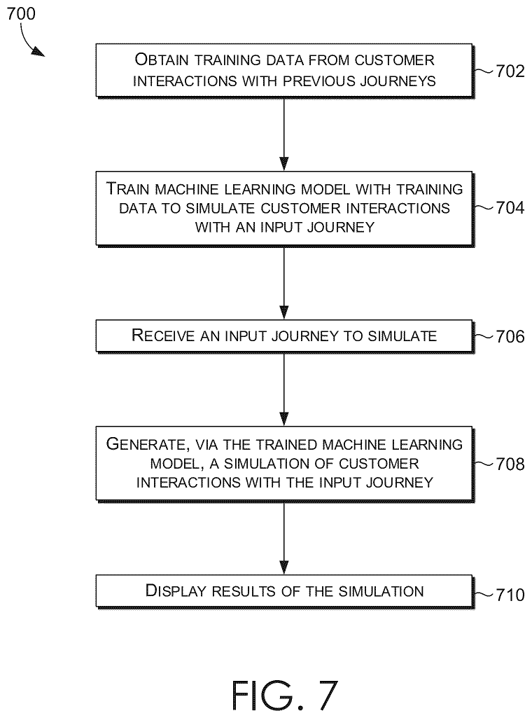

With reference now to FIGS. 7-9, flow diagrams are provided showing exemplary methods 700-900 related to a transformer model for journey simulation and prediction, in accordance with embodiments of the present technology. Each block of methods 700-900 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 7-9 are exemplary only and not intended to be limiting. As can be appreciated, in some embodiments, method flows 700-900 can be implemented, at least in part, to facilitate a transformer model for journey simulation and prediction.

Turning initially to FIG. 7, a flow diagram is provided showing an embodiment of a method 700 for a transformer model for journey simulation and prediction in accordance with embodiments described herein. Such a transformer model for journey simulation and prediction can be used to efficiently and effectively simulate a customer journey without having to manually implement the customer journey. Initially, at block 702, training data is obtained from customer interactions with previous journeys. In some embodiments, the events of the training data are stored as JSONs with various fields. The events can include fields, such as time of the interaction, price of the product, location data for the customer (e.g., latitude and longitude, IP address, physical store address, etc.), website address for the web page visited by the customer, product type, or any data that a business/marketer includes in an event of a journey. Further, in some embodiments, the events can include fields related to customer demographic information and can include the customer's geographical location, economic status, customer gender, customer age, or any other relevant demographic data collected regarding the customer.

At block 704, the machine learning model is trained with the training data to simulate customer interactions with an input journey. In embodiments described herein, the machine learning model is a transformer-based machine learning model. In some embodiments, the training of the machine learning model includes training an embedding layer of the machine learning model to generate an embedding for each event in the input sequence of events of the input journey and training a transformer encoder layer of the machine learning model to generate a positional embedding for each embedding of each event in the input sequence of events of the input journey.

At block 706, an input journey is received and a user initiates the simulation of the input journey. At block 708, the trained machine learning model generates a simulation of customer interactions with the input journey. In some embodiments, the simulation of customer interaction with the input journey is generated based on positional embeddings determined for each event of the input sequence of events. In some embodiments, the simulation of customer interaction with the input journey is generated by generating, via an embedding layer, an embedding for each event in the input sequence of events of the input journey; generating, via a transformer encoder layer, a positional embedding for each embedding of each event in the input sequence of events of the input journey; and generating the simulation based at least on the positional embedding for each embedding of each event in the input sequence of events of the input journey.

At block 710, the results of the simulation are displayed. In some embodiments, the results of the simulation predicts a probability of customers triggering (e.g., interacting with) one or more events of the input sequence of events of the input journey. In some embodiments, the results of the simulation generates one or more predicted events for the journey.

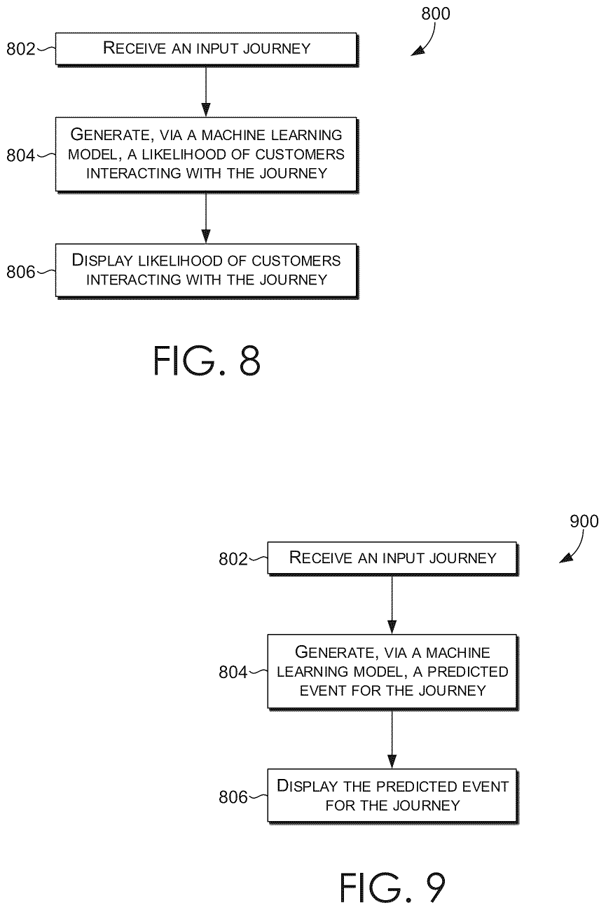

Turning now to FIG. 8, a flow diagram is provided showing an embodiment of a method 800 for a transformer model for journey simulation in accordance with embodiments described herein. Such a transformer model for journey simulation can be used to efficiently and effectively simulate a customer journey without having to manually implement the customer journey. Initially, at block 802, an input journey is received and a user initiates the simulation of the input journey. At block 804, the machine learning model generates a probability of customers triggering (e.g., interacting with) the journey.

At block 806, the probability of customers triggering (e.g., interacting with) the journey are displayed for the user. In this regards, the user can determine whether the simulated input journey achieves the outcome that the user desires. If satisfied the user can implement the journey for actual customers. If the user is not satisfied, the user can adjust the input journey and re-test the revised input journey through simulation without minimal loss of time. In some embodiments, additional predicted events are also displayed along with the input journey and the probability of the customers triggering (e.g., interacting with) the predicted events are displayed for the user.

Turning now to FIG. 9, a flow diagram is provided showing an embodiment of a method 900 for a transformer model for journey event prediction in accordance with embodiments described herein. Such a transformer model for journey event prediction can be used to efficiently and effectively predict events of a customer journey without having to manually implement the customer journey. Initially, at block 902, an input journey is received and a user initiates the simulation of the input journey. At block 904, the machine learning model generates one or more predicted events for the journey.

At block 906, the predicted events for the journey are displayed for the user. In some embodiments, the probability of customers triggering (e.g., interacting with) the predicted events of the journey are displayed for the user. In some embodiments, the predicted events are backpropogated into the machine learning model in order to simulate further customer interactions with the input journey.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 10 in particular, an exemplary operating environment for implementing aspects of the technology described herein is shown and designated generally as computing device 1000. Computing device 1000 is just one example of a suitable computing environment and is not intended to suggest any limitation as to the scope of use or functionality of the technology described herein. Neither should the computing device 1000 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 10, computing device 1000 includes a bus 1010 that directly or indirectly couples the following devices: memory 1012, one or more processors 1014, one or more presentation components 1016, input/output (I/O) ports 1018, I/O components 1020, an illustrative power supply 1022, and a radio(s) 1024. Bus 1010 represents what may be one or more busses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 10 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 10 and refer to “computer” or “computing device.”

Computing device 1000 typically includes a variety of computer-readable media. Computer-readable media can be any available media that can be accessed by computing device 1000 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1012 includes computer storage media in the form of volatile and/or nonvolatile memory. The memory 1012 may be removable, non-removable, or a combination thereof. Exemplary memory includes solid-state memory, hard drives, and optical-disc drives. Computing device 1000 includes one or more processors 1014 that read data from various entities such as bus 1010, memory 1012, or I/O components 1020. Presentation component(s) 1016 present data indications to a user or other device. Exemplary presentation components 1016 include a display device, speaker, printing component, and vibrating component. I/O port(s) 1018 allow computing device 1000 to be logically coupled to other devices including I/O components 1020, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 1014 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 1000. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 1000. The computing device 1000 may be equipped with depth cameras, such as stereoscopic camera systems, infrared camera systems, RGB camera systems, and combinations of these, for gesture detection and recognition. Additionally, the computing device 1000 may be equipped with accelerometers or gyroscopes that enable detection of motion. The output of the accelerometers or gyroscopes may be provided to the display of the computing device 1000 to render immersive augmented reality or virtual reality.

A computing device may include radio(s) 1024. The radio 1024 transmits and receives radio communications. The computing device may be a wireless terminal adapted to receive communications and media over various wireless networks. Computing device 1000 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive. The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

1. A computer-implemented method comprising:
obtaining, by a model training engine, training data from a plurality of journeys, each journey comprising a sequence of events, wherein the training data from each journey indicates customer interaction with each event in the sequence of events of the journey;
training, by the model training engine using the training data, a machine learning model to simulate customer interaction with an input journey comprising an input sequence of events;
simulating, by the trained machine learning model, customer interaction with the input journey; and
causing, by a user interface component, display of results of the simulated customer interaction with the input journey.

2. The computer-implemented method of claim 1, wherein the results of the simulated customer interaction with the input journey predicts a probability of customers triggering one or more events of the input sequence of events of the input journey.

3. The computer-implemented method of claim 1, wherein the results of the simulated customer interaction with the input journey predicts one or more predicted events based on the input journey.

4. The computer-implemented method of claim 1, wherein the machine learning model is a transformer-based machine learning model and the customer interaction with the input journey is simulated based on positional embeddings determined for each event of the input sequence of events.

5. The computer-implemented method of claim 1, wherein the training, by the model training engine using the training data, the machine learning model to simulate customer interaction with the input journey further comprises:
training an embedding layer of the machine learning model to generate an embedding for each event in the input sequence of events of the input journey; and
training a transformer encoder layer of the machine learning model to generate a positional embedding for each embedding of each event in the input sequence of events of the input journey.

6. The computer-implemented method of claim 1, further comprising:
obtaining customer data for each customer of the plurality of journeys of the training data, wherein the customer data comprises demographic data; and
further training the machine learning model to simulate customer interaction with the input journey using the customer data.

7. The computer-implemented method of claim 1, further comprising:
wherein the training data further comprises data indicating a time of the customer interactions with each event in the sequence of events of each journey of the plurality of journeys; and
further training the machine learning model to simulate customer interaction with the input journey using the time of the customer interactions.

8. The computer-implemented method of claim 1, wherein the simulating, by the trained machine learning model, customer interaction with the input journey further comprises:
generating, by an embedding layer, an embedding for each event in the input sequence of events of the input journey;
generating, by a transformer encoder layer, a positional embedding for each embedding of each event in the input sequence of events of the input journey; and
simulating the customer interaction with the input journey based at least on the positional embedding for each embedding of each event in the input sequence of events of the input journey.

9. A non-transitory computer-readable medium storing executable instructions, which when executed by a processing device, cause the processing device to perform operations comprising:
obtaining a journey, the journey comprising a sequence of events;
predicting, by a machine learning model, a predicted event based on the sequence of events of the journey; and
causing display of the predicted event.

10. The media of claim 9, wherein the machine learning model is a transformer-based machine learning model and the predicted event is predicted based on positional embeddings of each event in the sequence of events of the journey.

11. The media of claim 9, the method further comprising:
obtaining training data from a plurality of journeys, each journey of the plurality of journeys comprising a sequence of events, wherein the training data indicates customer interactions with each event in the sequence of events of each journey of the plurality of journeys; and
training, using the training data, the machine learning model to predict the predicted event based on the sequence of events of the journey, the training comprising:
training an embedding layer of the machine learning model to generate an embedding for each event of the sequence of events of the journey; and
training a transformer encoder layer of the machine learning model to generate a positional embedding for each embedding of each event of the sequence of events of the journey.

12. The media of claim 11, the method further comprising:
obtaining customer data for each customer of the plurality of journeys of the training data, wherein the customer data comprises demographic data; and
further training the machine learning model to predict the predicted event using the customer data.

13. The media of claim 11, the method further comprising:
wherein the training data further comprises data indicating a time of the customer interactions with each event in the sequence of events of each journey of the plurality of journeys; and
further training the machine learning model to predict the predicted event using the time of the customer interactions.

14. The media of claim 9, wherein the predicting, by the machine learning model, the predicted event based on the sequence of events of the journey further comprises:
generating, by an embedding layer, an embedding for each event in the sequence of events of the journey;
generating, by a transformer encoder layer, a positional embedding for each embedding of each event in the sequence of events of the journey; and
predicting the predicted event based at least on the positional embedding for each embedding of each event in the sequence of events of the journey.

15. A computing system comprising:
a processor; and
a non-transitory computer-readable medium having stored thereon instructions that when executed by the processor, cause the processor to perform operations including:
obtaining, by a machine learning model, a journey, the journey comprising a sequence of events;
predicting, by the machine learning model, a probability of customers triggering one or more events of the sequence of events of the journey; and
causing, by the user interface component, display of the probability of customers triggering one or more events of the sequence of events of the journey.

16. The system of claim 15, wherein the machine learning model is a transformer-based machine learning model and the probability of customers triggering one or more events of the sequence of events of the journey is predicted based on positional embeddings of each event in the sequence of events of the journey.

17. The system of claim 15, wherein the instructions that when executed by the processor, cause the processor to perform operations further including:
obtaining, by a model training engine, training data from a plurality of journeys, each journey of the plurality of journeys comprising a sequence of events, wherein the training data indicates customer interactions with each event in the sequence of events of each journey of the plurality of journeys; and
training, by the model training engine using the training data, the machine learning model to predict the probability of customers triggering one or more events of the sequence of events of the journey, the training comprising:
training an embedding layer of the machine learning model to generate an embedding for each event of the sequence of events of the journey; and
training a transformer encoder layer of the machine learning model to generate a positional embedding for each embedding of each event of the sequence of events of the journey.

18. The system of claim 17, wherein the instructions that when executed by the processor, cause the processor to perform operations further including:
obtaining customer data for each customer of the plurality of journeys of the training data, wherein the customer data comprises demographic data; and
further training the machine learning model to predict the probability of customers triggering one or more events of the sequence of events of the journey using the customer data.

19. The system of claim 17, wherein the instructions that when executed by the processor, cause the processor to perform operations further including:
wherein the training data further comprises data indicating a time of the customer interactions with each event in the sequence of events of each journey of the plurality of journeys; and
further training the machine learning model to predict the probability of customers triggering one or more events of the sequence of events of the journey using the time of the customer interactions.

20. The system of claim 15, wherein the instructions that when executed by the processor, cause the processor to perform operations further including:
wherein the predicting, by the machine learning model, the probability of customers triggering one or more events of the sequence of events of the journey further comprises:
generating, by an embedding layer, an embedding for each event in the sequence of events of the journey;
generating, by a transformer encoder layer, a positional embedding for each embedding of each event in the sequence of events of the journey; and
predicting the probability of customers triggering one or more events of the sequence of events of the journey based at least on the positional embedding for each embedding of each event in the sequence of events of the journey.
